(19) United States
(12) Patent Application Publication
(10) Pub. No.: US 2015/0349959 A1
(43) Pub. Date: Dec. 3, 2015

(54) User Authentication Retry with a Biometric Sensing Device

(71) Applicant: Apple Inc., Cupertino, CA (US)

(72) Inventor: Craig A. Marciniak, Cupertino, CA (US)

(21) Appl. No.: 14/723,298

(22) Filed: May 27, 2015

Related U.S. Application Data
(60) Provisional application No. 62/005,183, filed on May 30, 2014.

(51) Int. Cl. H04L 9/32

(52) U.S. Cl. CPC H04L 9/3231

(57) ABSTRACT

An electronic device includes, or is connected to, a biometric sensing device. A non-textual graphical element may be displayed when a biometric image received from the biometric sensing device does not match a reference biometric image. The non-textual graphical element indicates a number of authentication retries remaining for the user. The non-textual graphical element is modified when another biometric image received from the biometric sensing device does not match the reference biometric image. The non-textual graphical element is modified to indicate that a fewer number of authentication retries remain for the user.

### CROSS-REFERENCE TO RELATED APPLICATION

This application claims the benefit under 35 U.S.C. §119(e) of U.S. Provisional Patent Application No. 62/005,183, filed May 30, 2014, entitled “User Authentication Retry with a Biometric Sensing Device,” the entirety of which is incorporated herein by reference.

### TECHNICAL FIELD

The present invention relates to electronic devices, and more particularly to a biometric sensing device included in, or connected to an electronic device.

### BACKGROUND

Passwords are a common security tool for applications, websites, and devices. A user-entered password must match a reference password before the user is given access or allowed to interact with an application, website, or device. But passwords can have a number of limitations. The number of characters that can be included in the password can be limited to a maximum number, such as eight or twelve characters. Additionally, a user can be prohibited from using certain types of characters in their password. For example, in some systems a password may not include symbols such as a pound or hash symbol (#), an exclamation sign (!), and a percent sign (%).

Randomly generated passwords can be more secure than passwords selected by a user, but randomly generated passwords can be difficult to remember. Some users therefore select less secure passwords that are easier to remember. For example, a password that includes a complete word, the user's birthday, or a company name may be easier for a user to remember. Such passwords, however, can also be easier to guess or discover.

The use of biometric data can provide a greater level of security to a device or application compared to passwords. Biometric sensing devices can detect or image a unique physical or behavioral trait of a person and produce biometric data that can reliably identify the person. For example, a fingerprint generally includes a unique pattern of ridges and valleys that can be imaged by a fingerprint sensing device. The image of the fingerprint, or the unique characteristics of the fingerprint, is compared to previously captured reference data, such as a reference fingerprint image. The identity of the person is obtained or verified when the newly captured fingerprint image matches the reference fingerprint image.

The number of biometric images that can be submitted to authenticate a user can be restricted in some electronic devices for security reasons. Thus, if newly submitted biometric images do not match a reference biometric image for the given number of submissions, the user may be required to perform an additional security operation to gain access to the electronic device, or to access an application or function in the electronic device. In some situations, however, it can be difficult for the user to know how many biometric image submissions remain before he or she will need to perform the additional security operation. For example, a child or a friend can use the electronic device and attempt to submit one or more biometric images without the user's knowledge. If each submission results in a failed match, the total number of allowed submissions is reduced, and the user has a fewer number of submission retries remaining. This remaining number of retries is unknown the user, and when the user has one or more failed matches and the number of failed matches meets the number of allowed submissions, the user may be surprised and unhappy when he or she is required to perform the additional security operation.

### SUMMARY

Embodiments described herein provide a non-graphical textual element to a user that indicates the number of remaining biometric image submissions. In one aspect, a method for authenticating a user using a biometric sensing device includes displaying a non-textual graphical element when a first biometric image does not match a reference biometric image. As described earlier, the non-textual graphical element indicates a number of retries remaining for the user to submit biometric images. A second biometric image may then be received from the biometric sensing device. If the second biometric image does not match a reference biometric image, the non-textual graphical element is modified to indicate a decreased number of retries remaining for the user. A determination may be made as to whether or not a retry counter equals zero. If the retry counter equals zero, the user can be required to perform one or more additional security operations.

In another aspect, an electronic device can include a biometric sensing device, a display, and at least one processing device operatively connected to the biometric sensing device and to the display. The at least one processing device may be adapted to display a non-textual graphical element when a first biometric image does not match a reference biometric image. The non-textual graphical element indicates a number of retries remaining for the user to submit biometric images. The at least one processing device can be adapted to reduce the number of retries remaining to submit biometric images each time a biometric image does not match a reference image. The at least one processing device may be adapted to require a user to perform one or more additional security operations when the number of retries equals zero.

In another aspect, an electronic device can include a biometric sensing device, a display, an unsecure or general purpose processing device operatively connected to the display, a secure processing device operatively connected to the biometric sensing device, a secure memory operatively connected to the secure processing device, and a second memory operatively connected to the processing device. The secure processing device may be adapted to receive a biometric image and determine if the biometric image matches a reference biometric image stored in the secure memory. If the biometric image does not match a reference biometric image, the secure processing device can be adapted to transmit a signal to the unsecure processing device to cause the display to display a non-textual graphical element that indicates a number of retries remaining for biometric image submission. In one embodiment, the secure processing device may be adapted to maintain a retry counter in the secure memory and reduce the counter each time a biometric image does not match the reference biometric image. And the secure processing device can transmit a signal to the unsecure processing device to cause the display to display the non-textual graphical element indicating a reduced number of retries remaining for biometric image submission.

In another embodiment, the unsecure processing device can be adapted to maintain a retry counter in the second memory. The secure processing device may transmit a signal to the unsecure processing device when a biometric image does not match a reference biometric image and the first processing device can reduce the counter based on the failed match. In such an embodiment, the unsecure processing device can transmit a signal to the display to cause the display to display the non-textual graphical element indicating a reduced number of retries remaining for biometric image submission.

In another aspect, a method for modifying a number of biometric image submissions for an authentication process that utilizes a biometric sensing device can include determining if a request to modify the number of biometric image submissions has been received from a user, and if a request has been received, receiving a modified number, the modified number representing the number of biometric image submissions. The modified number can be a global number that applies to all applications and functions in the portable electronic device that are configured to use the authentication process. The user may also specify an amount of time in which the biometric images must be received during the authentication process.

In some embodiments, a non-textual graphical element can be displayed to a user at one or more different times. As one example, a non-textual graphical element can be displayed to a user when the user is required to submit a biometric image. The non-textual graphical element may then be modified when a biometric image does not match a reference biometric image. Additionally or alternatively, a non-textual graphical element can be displayed to a user only when a certain number of submission retries remain (e.g., when only one submission retries remain).

In some embodiments, a textual notice can be displayed with the non-textual graphical element.

### BRIEF DESCRIPTION OF THE DRAWINGS

Embodiments of the invention are better understood with reference to the following drawings. The elements of the drawings are not necessarily to scale relative to each other. Identical reference numerals have been used, where possible, to designate identical features that are common to the figures.

FIG. 1 is a perspective view of an example electronic device that can include a biometric sensing device;

FIG. 2 is an illustrative block diagram of the electronic device 100 shown in FIG. 1;

FIG. 3 is a flowchart of one example of a method for fingerprint authentication with a fingerprint sensing device;

FIG. 4 depicts a process flow for the method shown in FIG. 3;

FIGS. 5A-5B illustrate a first example of a non-textual graphical element suitable for use in blocks 306 and 314 in FIG. 3;

FIGS. 6A-6B depict a second example of a non-textual graphical element suitable for use in blocks 306 and 314 in FIG. 3;

FIGS. 7A-7B illustrate a third example of a non-textual graphical element suitable for use in blocks 306 and 314 in FIG. 3;

FIGS. 8A-8C depict a fourth example of a non-textual graphical element suitable for use in blocks 306 and 314 in FIG. 3;

FIG. 9 is a flowchart of a method for modifying a count that defines a number of fingerprint submissions; and

FIG. 10 illustrates example menus suitable for use in blocks 900, 904, and 908 in FIG. 9.

### DETAILED DESCRIPTION

The present disclosure recognizes that personal information data, including biometric data, in the present technology, can be used to the benefit of users. For example, the use of biometric authentication data can be used for convenient access to device features without the use of passwords. In other examples, user biometric data is collected for providing users with feedback about their health or fitness levels. Further, other uses for personal information data, including biometric data, that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure, including the use of data encryption and security methods that meet or exceed industry or government standards. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data, including biometric data. That is, the present disclosure contemplates that hardware and/or software elements can be provided to prevent or block access to such personal information data. For example, in the case of biometric authentication methods, the present technology can be configured to allow users to optionally bypass biometric authentication steps by providing secure information such as passwords, personal identification numbers (PINS), touch gestures, or other authentication methods, alone or in combination, known to those of skill in the art. In another example, users can select to remove, disable, or restrict access to certain health-related applications collecting users' personal health or fitness data.

Embodiments described herein display a non-graphical textual element to a user that indicates the number of remaining biometric image submissions for that user. In some embodiments, the non-graphical textual element can be displayed the first time a user submits a biometric image. In other embodiments, the non-graphical textual element is displayed only when a biometric image fails to match a reference biometric image. The non-graphical textual element may be modified and displayed to the user each time a biometric image does not match a reference biometric image or at select remaining submissions (e.g., the third and then the last). The modified non-textual graphical element is adjusted to indicate the number of remaining biometric image submissions, or the number of retries the user has for biometric authentication. In some embodiments, a textual notice can be displayed with the non-textual graphical element.

The non-textual graphical element can have any desired design and dimensions. As one example, the non-textual graphical element can be configured as a pie chart with the number of slices in the pie representing the total number of biometric image submissions. A slice of the pie can be shaded or deleted each time a biometric image does not match a reference biometric image. When all of the slices are shaded or the pie is empty (no remaining slices), the user may be required to perform one or more additional security operations.

Any suitable type of biometric sensing device can be included in, or connected to an electronic device. A person's fingerprint, eye, DNA, vein patterns, typing speed or patterns, gait, voice, face, and heart or brain signals are examples of a physical characteristic or a behavioral trait that can be detected or imaged by a biometric sensing device. A biometric sensing device can employ capacitance, ultrasonic, optical, resistive, thermal, or other sensing technologies to detect or image a biometric attribute. The term “biometric attribute” is meant to encompass a physical or behavioral trait that can be detected by a biometric sensing device.

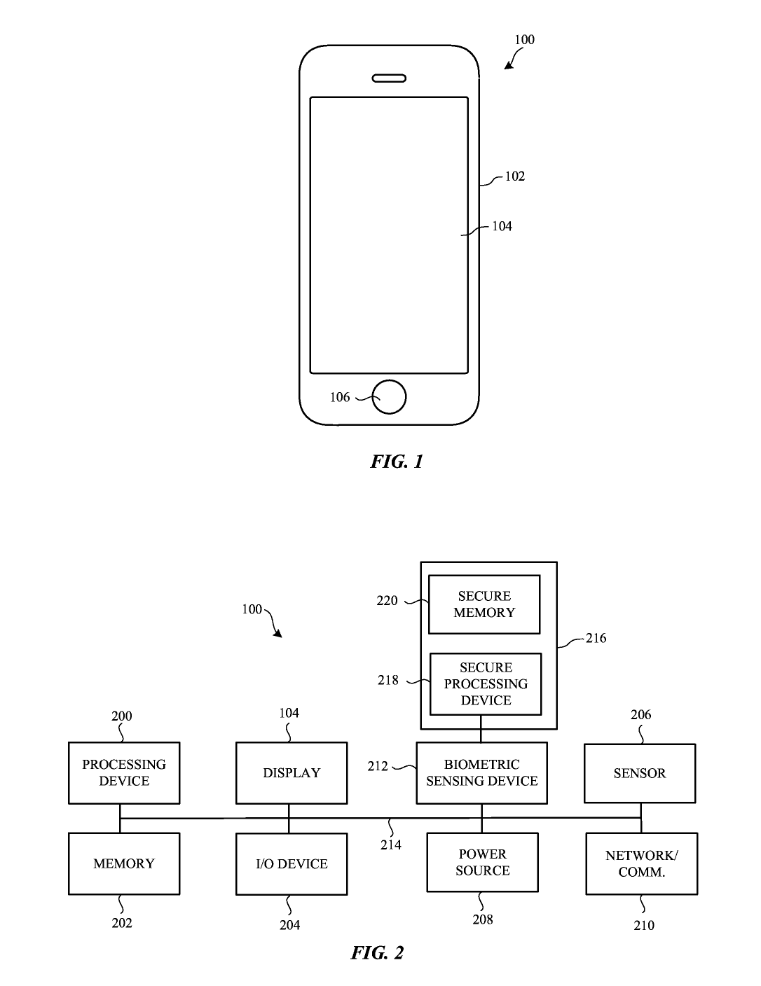

Referring now to FIG. 1, there is shown a perspective view of one example of an electronic device that can include, or be connected to a biometric sensing device. In the illustrated embodiment, the electronic device 100 is implemented as a smart telephone. Other embodiments can implement the electronic device differently, such as, for example, as a laptop or desktop computer, a tablet computing device, a gaming device, a display, a digital music player, a wearable communication device, and other types of electronic devices that can receive biometric data from a biometric sensing device.

The electronic device 100 includes an enclosure 102 at least partially surrounding a display 104 and one or more buttons 106 or input and/or output devices. The enclosure 102 can form an outer surface or partial outer surface for the internal components of the electronic device 100, and may at least partially surround the display 104. The enclosure 102 can be formed of one or more components operably connected together, such as a front piece and a back piece. Alternatively, the enclosure 102 can be formed of a single piece operably connected to the display 104.

The display 104 can be implemented with any suitable technology, including, but not limited to, a multi-touch sensing touchscreen that uses liquid crystal display (LCD) technology, light emitting diode (LED) technology, organic light-emitting display (OLED) technology, organic electroluminescence (OEL) technology, or another type of display technology.

The button 106 can take the form of a home button, which may be a mechanical button, a soft button (e.g., a button that does not physically move but still accepts inputs), an icon or image on a display, and so on. Further, in some embodiments, the button 106 can be integrated as part of a cover glass of the electronic device. Additionally, the electronic device 100 may include one or more other input/output devices, such as, for example, a microphone, a speaker, and a camera.

FIG. 2 is an illustrative block diagram of the electronic device 100 shown in FIG. 1. The electronic device 100 can include the display 104, one or more processing devices 200, memory 202, one or more input/output (I/O) devices 204, one or more sensors 206, a power source 208, a network communications interface 210, and a biometric sensing device 212. The display 104 may provide an image or video output for the electronic device 100. The display may also provide an input region for one or more input devices, such as, for example, a touch sensing device and/or a fingerprint sensing device. The display 104 may be substantially any size and may be positioned substantially anywhere on the electronic device 100.

The one or more processing devices 200 can control some or all of the operations of the electronic device 100. The processing device(s) 200 can communicate, either directly or indirectly, with substantially all of the components of the electronic device 100. For example, a system bus or signal line 214 or other communication mechanisms can provide communication between the one or more processing devices 200, the memory 202, the I/O device(s) 204, the one or more sensors 206, the power source 208, the network communications interface 210, and/or the biometric sensing device 212. The processing device(s) 200 can be implemented as any electronic device capable of processing, receiving, or transmitting data or instructions. For example, the processing device 200 can be a microprocessor, a central processing unit (CPU), an application-specific integrated circuit (ASIC), a digital signal processor (DSP), or combinations of such devices. As described herein, the term “processing device” is meant to encompass a single processor or processing unit, multiple processors, multiple processing units, or other suitably configured computing element or elements.

The memory 202 can store electronic data that can be used by the electronic device 100. For example, a memory can store electrical data or content such as, for example, audio and video files, documents and applications, device settings and user preferences, timing signals, biometric data, data structures or databases, information associated with the biometric sensing device 212 (e.g., a retry counter), and so on. The memory 202 can be configured as any type of memory. By way of example only, the memory can be implemented as random access memory, read-only memory, Flash memory, removable memory, or other types of storage elements, or combinations of such devices.

The one or more I/O devices 204 can transmit and/or receive data to and from a user or another electronic device. One example of an I/O device is button 106 in FIG. 1. The I/O device(s) 204 can include a display, a touch sensing input surface such as a track pad, one or more buttons, one or more microphones or speakers, one or more ports such as a microphone port, and/or a keyboard.

The electronic device 100 may also include one or more sensors 206 positioned substantially anywhere on the electronic device 100. The sensor or sensors 206 may be configured to sense substantially any type of characteristic, such as but not limited to, images, pressure, light, touch, heat, movement, relative motion, and so on. For example, the sensor(s) 206 may be an image sensor, a heat sensor, a light or optical sensor, an accelerometer, a pressure transducer, a gyroscope, a magnet, a health monitoring sensor, and so on.

The power source 208 can be implemented with any device capable of providing energy to the electronic device 100. For example, the power source 208 can be one or more batteries or rechargeable batteries, and/or a connection cable that connects the remote control device to another power source such as a wall outlet.

The network communication interface 210 can facilitate transmission of data to or from other electronic devices. For example, a network communication interface can transmit electronic signals via a wireless and/or wired network connection. Examples of wireless and wired network connections include, but are not limited to, cellular, Wi-Fi, Bluetooth, IR, and Ethernet.

The biometric sensing device 212 can incorporate any suitable sensing technology, including, but not limited to, capacitive, resistive, ultrasound, piezoelectric, and thermal sensing technology. In some embodiments, the biometric sensing device 212 may be connected to a secure processing system 216. The secure processing system 216 can be included in the electronic device 100, in the biometric sensing device 212, or in a separate electronic device that is operatively connected to the biometric sensing device 212. The secure processing system 216 can include a secure processing device 218 and a secure memory 220 operatively connected to the secure processing device 218. Any suitable processing device and memory can be used in the secure processing system 216. And in some embodiments, other components can be included in the secure processing system.

The secure processing system 216 can receive biometric images captured by the biometric sensing device. The secure memory 220 may store the captured biometric images, information associated with the biometric image, such as a retry counter, and reference biometric data. The secure processing device 218 can manipulate the secure data stored in the secure memory 220, including the biometric images and the retry counter. The processing device 200 can be prohibited from accessing the biometric images received from the biometric sensing device 212 and the secure data stored in the secure memory 220, which increases the security of the secure data. For example, the secure data is inaccessible or less accessible to other programs that may be running on the processing device 200.

It should be noted that FIGS. 1 and 2 are illustrative only. In other examples, an electronic device may include fewer or more components than those shown in FIGS. 1 and 2. For example, some of the components shown in FIG. 2 can be implemented in a separate electronic device that is operatively connected to the electronic device 100 through a wired or wireless connection. As described earlier, the secure processing system 216 can be included in a separate electronic device. Additionally or alternatively, in some embodiments the display or at least one I/O device can be included in a separate electronic device.

In the embodiments described herein, the biometric sensing device is described as a fingerprint sensing device. Other embodiments, however, are not limited to a fingerprint sensing device and fingerprint images. Any suitable type of biometric sensing device can be used to detect a biometric attribute.

A fingerprint sensing device can capture images of one or more fingers, a portion of one or more fingers, and/or some or all of a palm or of a hand. In some embodiments, the fingerprint sensing device is positioned at a location that a user's finger, fingers and/or hands are naturally in contact with as the user interacts with the electronic device. For example, the electronic device 100 shown in FIG. 1 can include a fingerprint sensing device in the display 104, the button 106, the enclosure 102, and/or as a separate device that is connected to the electronic device 100.

As used herein, the terms “image” and “biometric image” include an image and other types of data that can be captured by a biometric sensing device. The term “biometric image” may also include a composite image or data created at least in part with the captured image and/or other data. The term “fingerprint image” includes an image, a composite image, and other types of data that can be captured or created by a fingerprint sensing device or a processing device using data captured by the fingerprint sensing device. By way of example only, a fingerprint sensing device can produce a data structure that defines the features in a fingerprint. Additionally, the term “fingerprint image” is meant to encompass an image or other data relating to a fingerprint of some or all of one or more fingers, some or all of a palm, some or all of a hand, and various combinations thereof. The term “finger” is meant to encompass one or more fingers, some or all of a palm, some or all of a hand, and various combinations thereof.

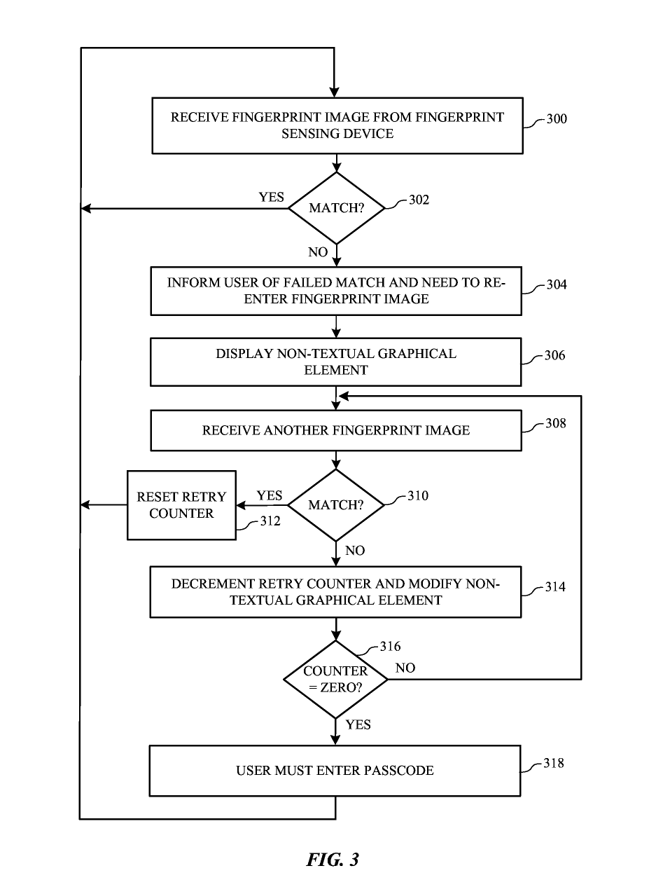

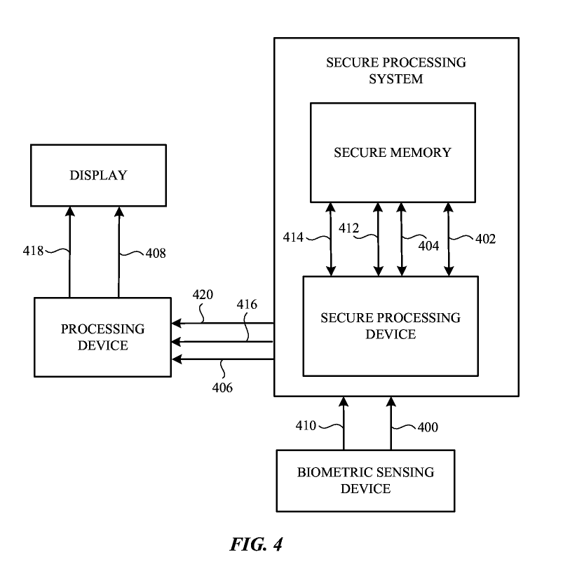

Referring now to FIG. 3, there is shown a flowchart of one example of a method for fingerprint authentication with a fingerprint sensing device. FIG. 4 is a data flow diagram of the method shown in FIG. 3. Initially, a fingerprint image is received from the fingerprint sensing device (block 300). In some embodiments, the fingerprint image is received by a secure processing system (step 400 in FIG. 4). A determination is then made at block 302 as to whether or not the fingerprint image matches a reference fingerprint image. As one example, a user can submit one or more fingerprint images as part of an enrollment process. At least one of the one or more fingerprint images may be saved as a reference fingerprint image. Newly captured fingerprint images may then be compared to the reference fingerprint image when authenticating the user.

In some embodiments, block 302 may be performed by a secure processing device in the secure processing system. The secure processing device can compare the fingerprint image with a reference fingerprint image stored in the secure memory (see step 402 in FIG. 4) to determine if the two fingerprint images match.

If the fingerprint image matches a reference fingerprint image, the method ends. If the fingerprint image does not match a reference fingerprint image, the process passes to block 304 where the user is informed that he or she must re-submit a fingerprint image. In other words, the user is informed that the fingerprint image did not match the reference fingerprint image (i.e., no match). A non-textual graphical element can then be displayed to the user illustrating the number of fingerprint submission retries left before the user must perform one or more additional security operations (block 306). For example, in one embodiment a non-textual graphical element may show the user that four fingerprint submissions remain before the user is required to enter his or her passcode.

In some embodiments, block 304 can be performed by the secure processing device in the secure processing system. The secure memory may store a retry counter that the secure processing device accesses based on the non-matching fingerprint images (see step 404 in FIG. 4). The secure processing device can transmit a signal (step 406 in FIG. 4) to a general purpose or unsecure processing device that causes the unsecure processing device to transmit a signal to a display in the electronic device (step 408 in FIG. 4). As one example, the unsecure processing device may be the processing device 200 and the display the display 104 shown in FIG. 2. The non-textual graphical element is displayed on the display in response to receiving the signal from the unsecure processing device.

Referring again to FIG. 3, another fingerprint image is received and a determination is made as to whether or not the fingerprint image matches a reference image (blocks 308 and 310). If so, a retry counter may be reset at block 312 (if previously decremented) and the method ends. As described earlier, the retry counter represents a count of a number of fingerprint image submissions that remain in the authentication process before the user may be required to perform one or more additional security operations.

As described previously, the fingerprint sensing device can transmit the fingerprint image submitted at block 308 to the secure processing system (step 410 in FIG. 4). The secure processing device can determine if the fingerprint image matches a reference image. The secure processing device can compare the fingerprint image with a reference fingerprint image stored in the secure memory (see step 412 in FIG. 4). The retry counter for the user may be stored in the secure memory, and the secure processing device may also reset the retry counter when the fingerprint image matches the reference fingerprint image (step 412).

If the fingerprint image does not match a reference image at block 310, the method continues at block 314 where the retry counter is reduced by one and the non-textual graphical element is modified to reflect the modified count of the retry counter. A determination is then made at block 316 as to whether or not the retry counter equals zero. If not, the method returns to block 308 and repeats until a fingerprint image matches the reference image or until the retry counter equals zero. If the retry counter equals zero, the process passes to block 318 where the user may perform one or more additional security operations and the method ends.

As shown in block 318, the user can be required to enter a passcode, but other types of additional security operations may be used in addition to, or as an alternative to, the passcode. One example of an additional security operation is voice recognition or another type of biometric authentication. And in still other embodiments, various combinations of security operations may be required, such as entering a passcode, performing voice recognition, entering a passcode that is displayed on an authentication token, and/or submitting answers to one or more challenge questions.

In some embodiments, the secure processing device can access the retry counter in the secure memory and reduce the retry counter by one (step 414 in FIG. 4). The secure processing device may transmit a signal to the unsecure processing device (step 416) that causes the unsecure processing device to update the non-textual graphical element displayed on the display (step 418 in FIG. 4). When the retry counter equals zero, the secure processing device can transmit a signal to the unsecure processing device that causes the unsecure processing device to control the one or more additional security operations (step 420 in FIG. 4). Alternatively, the unsecure processing device can detect from the signal transmitted at step 416 that the retry counter equals zero and control the one or more additional security operations.

In another embodiment, the unsecure processing device can be adapted to maintain a retry counter in a memory (e.g., memory 202 in FIG. 2). The secure processing device may transmit a signal to the unsecure processing device when a biometric image does not match a reference biometric image and the unsecure processing device can reduce the counter based on the failed match. In such an embodiment, the unsecure processing device can transmit a signal to the display to cause the display to display the non-textual graphical element indicating a reduced number of retries remaining for biometric image submission.

In other embodiments, the secure processing device can control the one or more additional security operations when the retry counter equals zero. And in some embodiments, both the unsecure processing device and the secure processing device may control the one or more additional security operations.

In some embodiments, a retry counter is maintained for, and applies to the electronic device (e.g., to all of the fingerprint submissions received by electronic device). In other embodiments, a retry counter can be maintained for each user of an electronic device. In some embodiments, the number of allowed fingerprint submissions and the retry counter may be a global counter in that the retry counter applies to all applications and functions in the electronic device that authenticate a user with the biometric sensing device. In other embodiments, the number of fingerprint submissions and the retry counter are local in that they are associated with each application and function, with groups of applications and functions, or with select applications and functions. Additionally, embodiments can use any given number of retries for the number of fingerprint submissions and/or the retry counter. For example, in one embodiment, the number of fingerprint submissions is a global number of five and the retry counter has a count of four.

In some embodiments, the blocks shown in FIG. 3 can be performed in a different order and/or some blocks may be omitted or added. As one example, block 306 can be performed immediately after block 300 in one embodiment. Additionally or alternatively, block 304 can be omitted. Instead, the display of the non-textual graphical element can alert the user of the failed match and the need to re-enter his or her fingerprint.

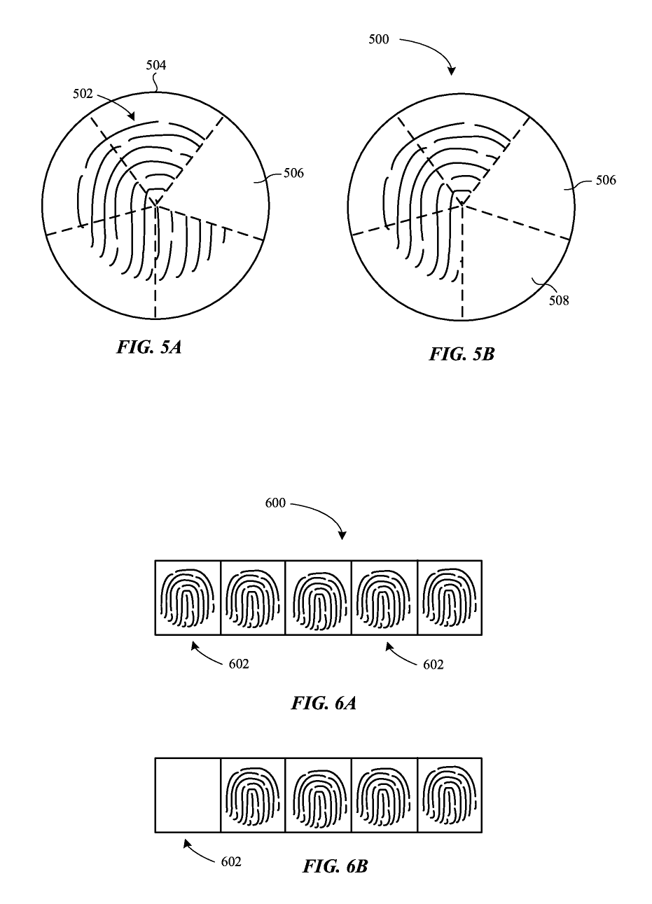

FIGS. 5A-5B illustrate a first example of a non-textual graphical element suitable for use in blocks 306 and 314 in FIG. 3. The non-textual graphical element 500 includes a representation of a fingerprint 502 included in a circle 504. The circle 504 may be similar to a pie chart in that the circle can be divided into slices, with the number of slices equaling the number of fingerprint submissions. A corresponding portion of the circle can be shaded or removed (e.g., blanked out) each time a fingerprint image does not match the reference fingerprint image until the entire circle is shaded or empty. For example, the circle in FIGS. 5A and 5B has been divided into five slices, with the total number of slices representing the number of fingerprint submissions. The dashed lines in FIGS. 5A and 5B that indicate the slices may or may not appear in the non-textual graphical element. In FIG. 5A, one slice 506 is removed, indicating one failed match. In FIG. 5B, two slices 506, 508 are removed to indicate two failed matches. The user may be required to perform the one or more additional security operations when all of the slices are shaded or are empty.

Referring now to FIGS. 6A-6B, there is shown a second example of a non-textual graphical element suitable for use in blocks 306 and 314 in FIG. 3. The non-textual graphical element 600 includes multiple representations of a fingerprint 602. The total number of fingerprint representations equals the number of fingerprint submissions. The fingerprint representations can be included in any suitable manner, such as in a rectangle similar to a progress bar or in a circle similar to a pie chart (with each fingerprint representation in a slice of the circle). A fingerprint representation can be shaded or removed each time a fingerprint image does not match the reference fingerprint image. For example, in FIGS. 6A and 6B there are five fingerprint portions. In FIG. 6A, all fingerprint representations are displayed, which indicates five remaining fingerprint submissions. In FIG. 6B, one fingerprint representation is removed, indicating a failed match. The user may be required to perform the one or more additional security operations when all of the fingerprint representations are shaded or are empty.

Alternatively, the progress bar can start out blank (i.e., with no fingerprint representations) and a fingerprint representation may be added each time there is a failed match until the progress bar is filled with fingerprint representations. The user may be required to perform the one or more additional security operations when all of the fingerprint representations are displayed in the progress bar.

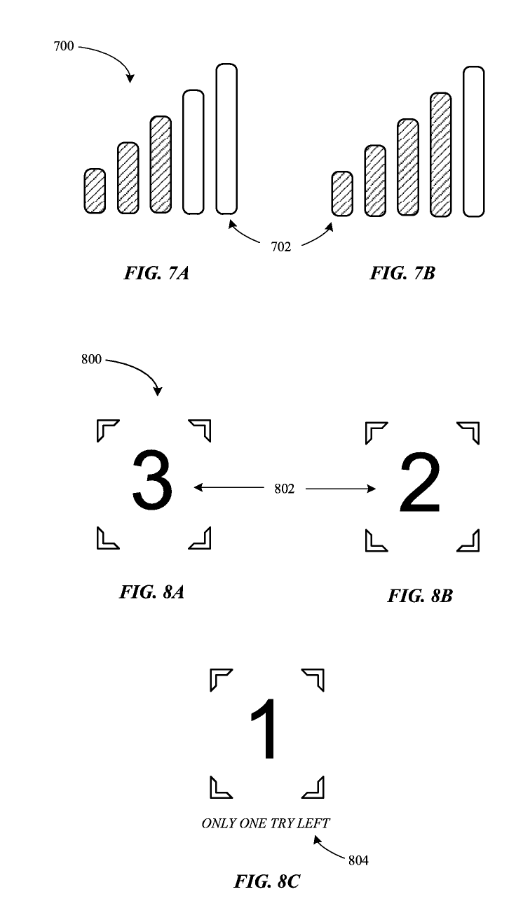

FIGS. 7A-7B depict a third example of a non-textual graphical element suitable for use in blocks 306 and 314 in FIG. 3. The non-textual graphical element 700 includes multiple bars 702. The total number of bars equals the number of fingerprint submissions. The bars have a rectangular shape in the illustrated embodiment, but in other embodiments the bars can have any given shape. Each time a fingerprint image does not match the reference fingerprint image, a bar can be shaded. Alternatively, a bar can be deleted each time a fingerprint image does not match the reference fingerprint image. For example, in FIGS. 7A and 7B there are five bars 702 in the non-textual graphical element 700. In FIG. 7A, three bars are shaded, which can indicate three failed matches. In FIG. 7B, four bars are shaded, which may indicate four failed matches. The user may be required to perform the one or more additional security operations when all of the fingerprint representations are shaded.

Referring now to FIGS. 8A-8C, there is shown a fourth example of a non-textual graphical element suitable for use in blocks 306 and 314 in FIG. 3. The non-textual graphical element 800 includes natural numbers 802. The total number of natural numbers equals the number of fingerprint submissions. The displayed number 802 can be reduced by one when a fingerprint image does not match the reference fingerprint image. For example, in FIG. 8A the number three is displayed, which indicates three remaining fingerprint submissions. In FIG. 8B, the displayed number 802 is reduced by one, indicating two remaining fingerprint submissions. And in FIG. 8C, the displayed number 802 is reduced by one again, indicating one remaining fingerprint submission. In some embodiments, a textual notice 804 can be provided to the user in addition to the non-textual graphical element. The textual notice can be displayed along with each non-textual graphical element, or a textual notice may be displayed along with one or more select non-textual graphical elements. As with the other example embodiments, the user may be required to perform the one or more additional security operations when the displayed number is zero.

In other embodiments, a non-textual graphical element can have any given design and dimensions. The non-textual graphical element informs a user as to the number of remaining fingerprint submissions (i.e., the number of retries) and/or the number of failed matches. One advantage to the non-textual graphical element is that it conveys this information without the need for a textual notice. Thus, the non-graphical textual element does not require translation or localization when implemented in electronic devices in multiple countries or on a global scale.

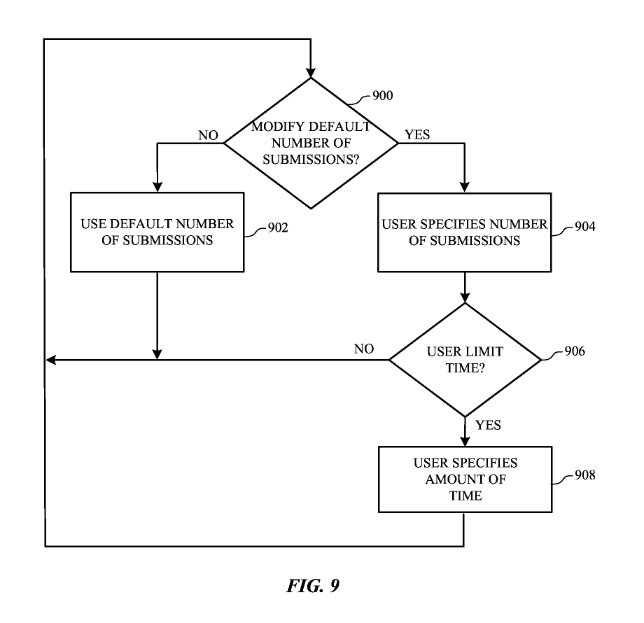

FIG. 9 is a flowchart of a method for modifying a default number that defines a number of allowed fingerprint submissions. Initially, at block 900, a determination may be made as to whether or not the user wants to modify the default number of fingerprint submissions. The total number of fingerprint submissions can be a global number or a local number. As described earlier, a global number of fingerprint submissions applies to all applications and functions in the electronic device that use fingerprints to authenticate or verify a user. A local number is a customized number of fingerprint submissions that applies to select applications and functions or groups of applications and functions that use fingerprints to authenticate or verify the user.

If the user will not modify the default number of fingerprint submissions, the process passes to block 902 where the default number of fingerprint submissions is used and the method ends. If the user will modify the default number of fingerprint submissions, the method continues at block 904 where the user enters a desired number of fingerprint submissions. A determination may then be made at block 906 as to whether or not the user wants to limit the amount of time in which a fingerprint image must be submitted. For example, if a fingerprint is not received within a given period of time, the submission can be considered a failed submission in some embodiments. In another embodiment, the non-receipt of the fingerprint image within a given period of time can cause the fingerprint authentication to end and a user can be required to perform the one or more additional security operations.

The method ends if the user does not want to limit the amount of time in which a fingerprint image must be submitted. If the user wants to limit the amount of time, the process passes to block 908 where the user enters a given amount of time and the method ends.

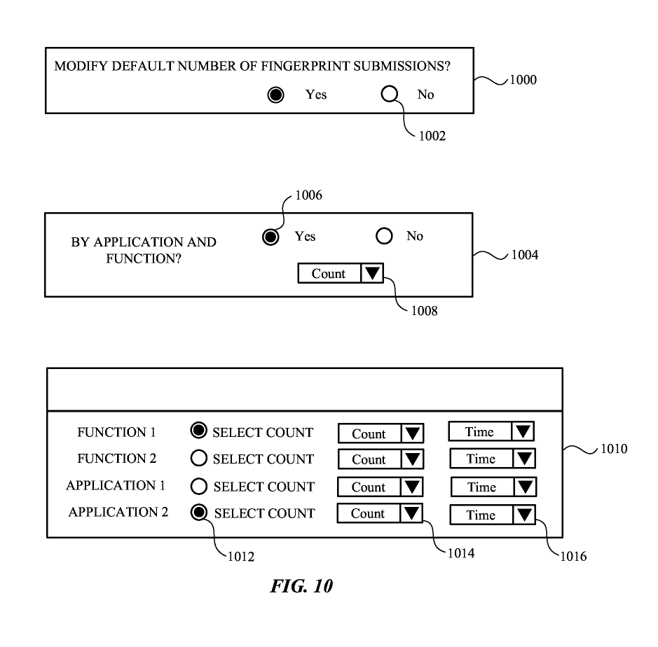

FIG. 10 illustrates example menus suitable for use in blocks 900, 904, and 908 in FIG. 9. The menu 1000 may be provided to the user at block 900. The user can select one of the radio buttons 1002 to indicate the user does (or does not) want to modify the default number of fingerprint submissions. If the user selects the “Yes” radio button, the menu 1004 can be displayed to the user. The menu 1004 can allow the user to select specific applications and/or functions that will have a modified number of fingerprint submissions. In some embodiments, the modified number of fingerprint submissions may be required to be less than the default number for security purposes. As one example, the default number of fingerprint submissions can be five, but a user can modify that number to three for his or her financial applications.

The user can select one of the radio buttons 1006 in the menu 1004 to indicate the user does (or does not) want to modify the number of fingerprint submissions for specific applications and/or functions. If the user selects the “No” radio button, the user can modify the number of fingerprint submissions using the drop-down menu 1008, and the selected number will function as a global number in that it applies to all applications and functions in the electronic device that authenticate a user with the biometric sensing device.

If the user selects the “Yes” radio button in the menu 1004, the menu 1010 may be displayed to the user. The user can select the radio buttons 1012 associated with specific applications and functions to indicate which applications and/or functions will have a modified number of fingerprint submissions. The user can then modify the number using the drop-down menus 1014. Additionally, if the user wants to limit the amount of time that the fingerprint images must be received by during each retry submission, the user may specify the amount of time using the drop-down menus 1016.

Other embodiments can construct and arrange the menu options differently. For example, a dialog box can be used instead of a drop-down menu.

As discussed earlier, the embodiments herein have been described with reference to a fingerprint sensing device and fingerprint images. Other embodiments, however, are not limited to a fingerprint sensing device and fingerprint images. Any suitable type of biometric sensing device can be used to detect or acquire images of a biometric attribute.

Various embodiments have been described in detail with particular reference to certain features thereof, but it will be understood that variations and modifications can be effected within the spirit and scope of the disclosure. And even though specific embodiments have been described herein, it should be noted that the application is not limited to these embodiments. In particular, any features described with respect to one embodiment may also be used in other embodiments, where compatible. Likewise, the features of the different embodiments may be exchanged, where compatible.

What is claimed is:

1. A method for authenticating a user using a biometric sensing device, the method comprising:
displaying a non-textual graphical element when a first biometric image does not match a reference biometric image, wherein the non-textual graphical element indicates a number of retries remaining for the user to submit biometric images;
receiving a second biometric image from the biometric sensing device; and
modifying the non-textual graphical element when the second biometric image does not match the reference biometric image, wherein the non-textual graphical element is modified to indicate a decreased number of retries remaining for the user.

2. The method as in claim 1, further comprising:
prior to displaying the non-textual graphical element, receiving the first biometric image from the biometric sensing device; and
determining if the first biometric image matches the reference biometric image.

3. The method as in claim 1, further comprising reducing a retry counter by one prior to modifying the non-textual graphical element, wherein a value of the retry counter equals the number of retries remaining for the user to submit biometric images.

4. The method as in claim 3, further comprising resetting the retry counter when the second biometric image matches the reference biometric image.

5. The method as in claim 3, further comprising:
determining if the retry counter equals zero; and
requiring the user to perform an additional security operation if the retry counter equals zero.

6. The method as in claim 5, wherein requiring the user to perform an additional security operation when the retry counter equals zero comprises requiring the user to enter a passcode when the retry counter equals zero.

7. The method as in claim 1, further comprising displaying a textual notice with the non-textual graphical element.

8. An electronic device comprising:
a biometric sensing device;
a display; and
at least one processing device operatively connected to the biometric sensing device and the display, wherein the at least one processing device is adapted to display a non-textual graphical element when a first biometric image does not match a reference biometric image, wherein the non-textual graphical element indicates a number of retries remaining to submit biometric images.

9. The electronic device as in claim 8, further comprising a memory to store the reference biometric image.

10. The electronic device as in claim 8, wherein the at least one processing device is adapted to reduce the number of retries remaining to submit biometric images each time a biometric image does not match a reference image.

11. The electronic device as in claim 10, wherein the at least one processing device is adapted to require a user to perform one or more additional security operations when the number of retries equals zero.

12. The electronic device as in claim 8, wherein the electronic device comprises a smart telephone.

13. The electronic device as in claim 8, wherein the biometric sensing device comprises a fingerprint sensing device.

14. An electronic device, comprising:
a biometric sensing device;
a display;
a first processing device operatively connected to the display;
a secure processing device operatively connected to the biometric sensing device; and
a secure memory operatively connected to the secure processing device, wherein the secure processing device is adapted to receive a biometric image and determine if the biometric image matches a reference biometric image stored in the secure memory, and if the biometric image does not match a reference biometric image, the secure processing device is adapted to transmit a signal to the first processing device to cause the display to display a non-textual graphical element that indicates a number of retries remaining for biometric image submission.

15. The electronic device as in claim 14, wherein the secure processing device is adapted to maintain a retry counter in the secure memory and reduce the counter each time a biometric image does not match the reference biometric image.

16. The electronic device as in claim 15, wherein the secure processing device transmits another signal to the first processing device to cause the display to display the non-textual graphical element indicating a reduced number of retries remaining for biometric image submission.

17. The electronic device as in claim 14, wherein the electronic device comprises a smart telephone.

18. The electronic device as in claim 14, wherein the biometric sensing device comprises a fingerprint sensing device.

19. A method for modifying a number of biometric image submissions for an authentication process performed in a portable electronic device, wherein the authentication process utilizes a biometric sensing device, the method comprising:
determining if a request to modify the number of biometric image submissions has been received from a user; and
if the request is received, receiving a modified number, the modified number representing the number of biometric image submissions.

20. The method as in claim 19, wherein the modified number is a global number that applies to all applications and functions in the portable electronic device that use the authentication process.
